(19) United States
(12) Patent Application Publication
(10) Pub. No.: US 2025/0200582 A1
(43) Pub. Date: Jun. 19, 2025

(54) SALES DATA PROCESSING SYSTEM

(71) Applicant: TOSHIBA TEC KABUSHIKI KAISHA, Tokyo (JP)

(72) Inventor: Hiroki Sakamoto, Mishima Shizuoka (JP)

(21) Appl. No.: 18/761,356

(22) Filed: Jul. 2, 2024

(30) Foreign Application Priority Data
Dec. 19, 2023 (JP) 2023-213619

(51) Int. Cl. G06Q 20/40; G06F 3/04817

(52) U.S. Cl. CPC G06Q 20/407; G06F 3/04817

(57) ABSTRACT

According to one embodiment, provided is a sales data processing system capable of simplifying cancellation of a commodity during checkout. A first processing unit includes a commodity registration unit that performs commodity registration processing of a commodity purchased by a customer. A second processing unit includes a declaration unit that receives a declaration of cancellation of a part or all of commodities subjected to the commodity registration processing, and a notification unit that notifies the cancellation of the commodity. The first processing unit includes a notification unit that receives the notification and notifies the cancellation of the commodity. The second processing unit includes a first acquisition unit that acquires information on a commodity to be cancelled, a cancellation processing unit that performs cancellation processing of the commodity, and a settlement processing unit that performs settlement processing of the commodities except for the commodity subjected to the cancellation processing.

### CROSS-REFERENCE TO RELATED APPLICATION

This application is based upon and claims the benefit of priority from Japanese Patent Application No. 2023-213619, filed on Dec. 19, 2023, the entire contents of which are incorporated herein by reference.

### FIELD

Embodiments described herein relate to a sales data processing system and a sales data processing method.

### BACKGROUND

In recent years, a store such as a supermarket is provided with a checkout system (a sales data processing system) including a first processing unit (for example, a registration machine) that performs commodity registration processing according to a commodity registration operation performed by a store clerk on a commodity purchased by a customer and a second processing unit (for example, a checkout machine) that is separate from the first processing unit and performs settlement processing according to a checkout operation performed by a customer on the commodity subjected to the commodity registration processing by the first processing unit.

In such a sales data processing system, when the customer performs the checkout operation in the second processing unit, if the customer stops purchasing one or a plurality of commodities subjected to the commodity registration processing by the first processing unit (hereinafter, referred to as “cancellation of a commodity”) when the customer performs the checkout operation in the second processing unit, it is necessary to notify a store clerk to cancel the commodity and cause the store clerk to perform a cancellation operation on the commodity. However, there is a case in which the store clerk starts the commodity registration operation for the next customer in the first processing unit, and in such a case, it is troublesome for the customer who cancels the commodity to notify the store clerk of the cancellation of the commodity.

### DESCRIPTION OF THE DRAWINGS

FIG. 1 is a schematic diagram showing a sales data processing system according to an embodiment;

FIG. 2 is a perspective view showing an appearance of the system;

FIG. 3 is a block diagram showing a hardware configuration of a registration machine;

FIG. 4 is a block diagram showing a hardware configuration of a checkout machine;

FIG. 5 is a block diagram showing a hardware configuration of a server;

FIG. 6 is a sequence diagram showing a flow of processing of the system;

FIG. 7 is a sequence diagram showing another flow of the processing;

FIG. 8 is a functional block diagram showing a functional configuration of the system;

FIG. 9 is a flowchart showing a flow of control processing performed in the registration machine;

FIG. 10 is a flowchart showing a flow of control processing performed in the checkout machine;

FIG. 11 is a diagram showing an example of a display screen of the registration machine;

FIG. 12 is a diagram showing an example of a display screen of the checkout machine; and

FIG. 13 is a flowchart showing a flow of control processing in a registration machine according to a modification.

### DETAILED DESCRIPTION

In general, according to one embodiment, provided is a sales data processing system capable of simplifying cancellation of a commodity during checkout.

The sales data processing system according to the embodiment includes: a first processing unit operated by a store clerk; and a second processing unit operated by a customer. The first processing unit includes a commodity registration unit configured to perform, based on an operation of the store clerk, commodity registration processing of a commodity purchased by the customer. The second processing unit includes a declaration unit configured to receive a declaration of cancellation of a part or all of commodities subjected to the commodity registration processing, and a notification unit configured to notify the first processing unit of the cancellation of the commodity by the declaration unit. The first processing unit includes a notification unit configured to receive the notification and notify the store clerk of the cancellation of the commodity. The second processing unit includes a first acquisition unit configured to acquire information on a commodity to be cancelled, which is designated based on the operation of the store clerk, a cancellation processing unit configured to perform cancellation processing of the commodity for which the information is acquired by the first acquisition unit among the commodities subjected to the commodity registration processing, and a settlement processing unit configured to perform, based on an operation of the customer, settlement processing of the commodities subjected to the commodity registration processing performed by the first processing unit except for the commodity subjected to the cancellation processing performed by the cancellation processing unit.

Hereinafter, an embodiment and a modification of a sales data processing system will be described with reference to the drawings. In the embodiment, a registration machine in which a store clerk performs a registration operation of a commodity purchased by a customer is described as an example of a first processing unit, and a checkout machine in which a customer performs a checkout operation is described as an example of a second processing unit. In the embodiment, a system including a registration machine and a checkout machine is an example of a sales commodity data processing system. The embodiment is not limited to the embodiment described below.

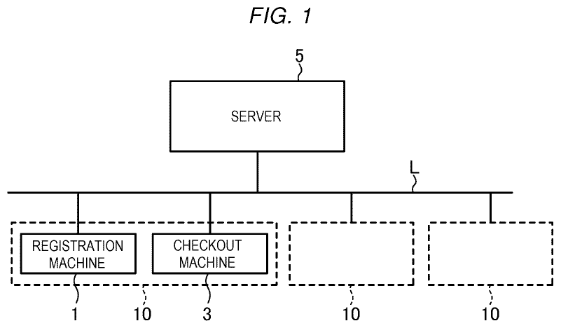

FIG. 1 is a schematic diagram showing a whole including a sales data processing system according to an embodiment. As shown in FIG. 1, a sales data processing system 10 includes a registration machine 1 (an example of the first processing unit) and a checkout machine 3 (an example of the second processing unit). The sales data processing system 10 is connected to a server 5. The registration machine 1, the checkout machine 3, and the server 5 are communicably connected to one another via a communication line L such as a local area network (LAN). One or a plurality of sales data processing systems 10 are connected to the server 5. In the embodiment, three sales data processing systems 10 are connected to the server 5. In each sales data processing system 10, the registration machine 1 and the checkout machine 3 to be paired are determined. In FIG. 1, the registration machine 1 and the checkout machine 3, which are surrounded by a dotted line, are paired, and various kinds of information are transmitted and received between the paired registration machine 1 and checkout machine 3. The paired registration machine 1 and checkout machine 3 construct the sales data processing system 10.

The registration machine 1 is installed in a checkout area of a store. The registration machine 1 images, for example, a symbol (for example, a bar code or a two-dimensional code) attached to a commodity with a camera and executes commodity registration processing of a commodity to be sold. The commodity registration processing includes processing of displaying and storing, based on commodity identification information (for example, a commodity code) identifying a commodity associated with the read (imaged) symbol, commodity information such as a commodity name and a price of the commodity. The registration machine 1 is operated by, for example, a store clerk or the like (hereinafter, referred to as a “store clerk”). An operation performed by the store clerk to cause the registration machine 1 to image the symbol attached to the commodity is referred to as a registration operation. The registration machine 1 may optically read the symbol attached to the commodity (for example, scanned by a scanner) to identify the commodity.

For example, if a transmission key is operated, the registration machine 1 transmits, to the checkout machine 3, the commodity information (a commodity code, a commodity name, a commodity price, and the like) of the commodity subjected to the commodity registration processing. In the embodiment, the registration machine 1 transmits the commodity information to the checkout machine 3 directly, but may transmit the commodity information to the checkout machine 3 via the server 5. In this case, the registration machine 1 transmits the commodity information to the server 5, and the server 5 stores the received commodity information. The checkout machine 3 inquires of the server 5 about the commodity information and receives the corresponding commodity information from the server 5. In the embodiment, the registration machine 1 transmits the commodity information to the paired checkout machine 3 via the communication line L. The registration machine 1 may be directly connected to the paired checkout machine 3 via a dedicated line and transmit the commodity information to the checkout machine 3.

The checkout machine 3 is installed close to the registration machine 1. Alternatively, the checkout machine 3 is installed at a position slightly away from the registration machine 1. The customer performs a checkout operation on the checkout machine 3. The checkout operation is an operation for the checkout machine 3 to perform settlement processing.

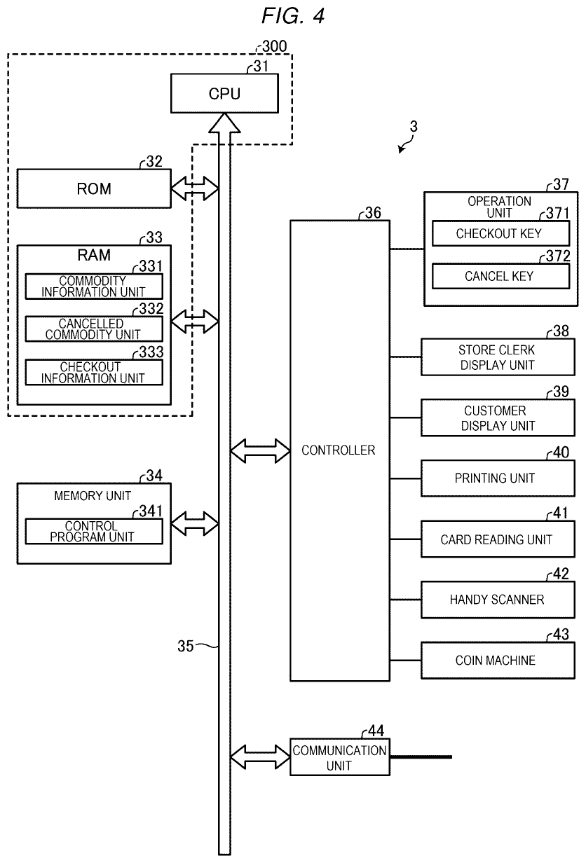

The checkout machine 3 stores the commodity information received from the registration machine 1 in a commodity information unit 331 (see FIG. 4). According to the checkout operation, the checkout machine 3 executes the settlement processing of the commodity (the commodity subjected to the commodity registration processing using the registration machine 1) stored in the commodity information unit 331. The settlement processing is processing of displaying settlement information such as a total amount, a deposit, and a coin amount related to a transaction with a customer based on commodity information on the commodity subjected to the commodity registration processing, and exchanging money with cash, a credit card, or the like. The settlement processing includes processing of dispensing a receipt on which the commodity information and the settlement information on a sold commodity are printed.

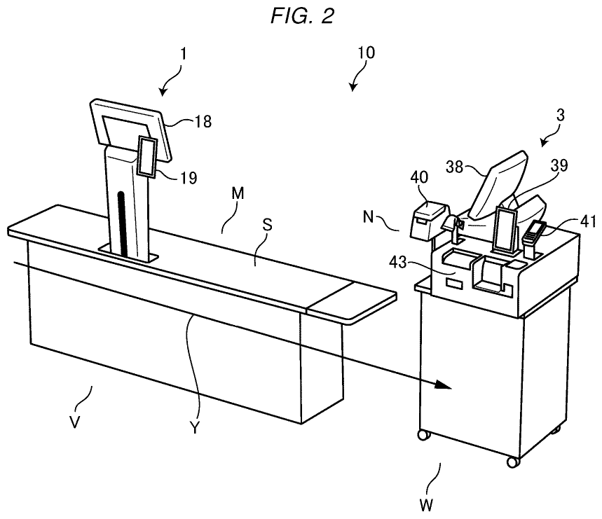

FIG. 2 is a perspective view showing an appearance of the sales data processing system 10. FIG. 2 shows a set of sales data processing system 10. The registration machine 1 and the checkout machine 3 are installed in a checkout area of a store. The registration machine 1 is attached to a long sacker table S. The sacker table S is a table on which a basket containing commodities is placed. The registration machine 1 is provided to stand upward from a part of the sacker table S. In FIG. 2, the store clerk is located at a position (a position M) facing the registration machine 1 on a back side of the sacker table S, and the customer is located at a position (a position V) facing the registration machine 1 on a front side of the sacker table S. The registration machine 1 includes a store clerk display unit 18 and a customer display unit 19 as a display unit. The store clerk display unit 18 is installed with a display surface facing the store clerk located near the position M, and displays (notifies) information to the store clerk. The customer display unit 19 is installed with a display surface facing the customer located near the position V, and displays (notifies) information to the customer located near the position V.

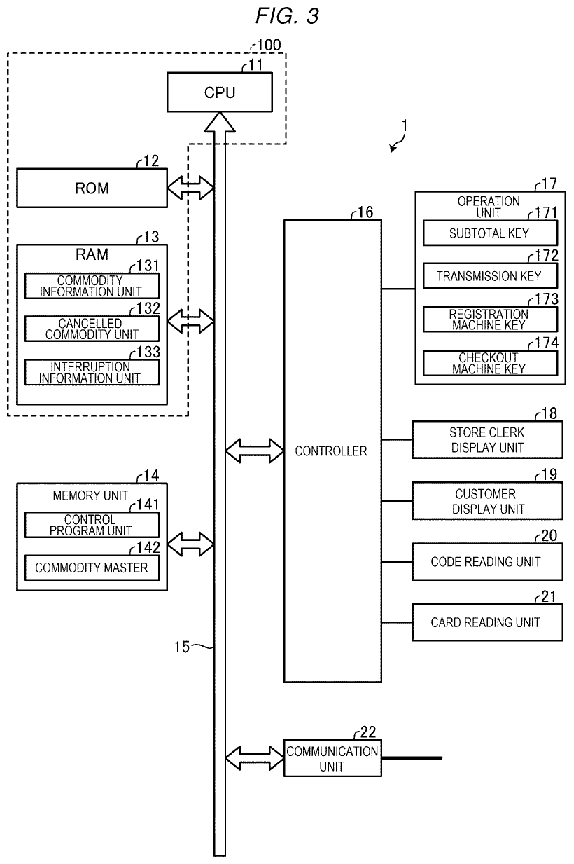

The store clerk picks up the commodities from the basket placed on the sacker table S and performs the commodity registration operation of holding the commodities over a code reading unit 20 (see FIG. 3). The code reading unit 20 images a commodity, and the registration machine 1 executes the commodity registration processing related to the commodity. The store clerk puts the commodities subjected to the commodity registration processing into a basket placed on the opposite side of the sacker table S. When the commodity registration processing is completed for all the commodities to be purchased, the customer moves to a position W in an arrow Y direction while holding the basket in which the commodities are contained, and performs the checkout operation in the checkout machine 3.

The checkout machine 3 is located downstream of the registration machine 1 in a customer flow direction (downstream of the registration machine 1 in the arrow Y direction in the embodiment). In the embodiment, the checkout machine 3 is installed near the registration machine 1 and downstream of the registration machine 1. In FIG. 2, the registration machine 1 and the checkout machine 3 are paired.

The checkout machine 3 includes a store clerk display unit 38 and a customer display unit 39 as the display unit. The store clerk display unit 38 is a display unit for the store clerk, is installed with a display surface facing the store clerk located near the position N, and displays (notifies) information to the store clerk. The customer display unit 39 is a display unit for the customer, is installed with a display surface facing the customer located near the position W, and displays (notifies) information to the customer. The checkout machine 3 includes a printing unit 40, a card reading unit 41, a handy scanner 42 (see FIG. 4), a coin machine 43, and the like. The printing unit 40 dispenses, to the customer located at the position W, a receipt on which the commodity information and the settlement information on the commodity subjected to the settlement processing are printed. The card reading unit 41 is a device used by a customer if settlement other than cash (for example, card settlement or code settlement) is performed. If the card settlement is performed, for example, the customer inserts a medium such as a credit card into the card reading unit 41 to perform the settlement. If the customer performs the settlement in cash, the customer inserts cash (bills or coins) equal to or greater than a total amount into the coin machine 43. If the inserted amount is larger than a payment amount and there is a change, the coin machine 43 dispenses the coins to the customer located at the position W. The printing unit 40, the card reading unit 41, and the coin machine 43 are installed toward the customer located at the position W. The handy scanner 42 is installed at a position where the store clerk at the position N can operate the handy scanner 42.

The customer who moves from the position (the position V) of the registration machine 1 to the position (the position W) of the checkout machine 3 performs the checkout operation using an operation unit 37 (see FIG. 4) in the form of a touch panel provided on a surface of the customer display unit 39. The checkout machine 3 executes the settlement processing based on the checkout operation by the customer. The customer who completes the payment (the settlement processing performed by the checkout machine 3) leaves the store while carrying the commodities.

The server 5 receives, from the checkout machine 3, the commodity information and the settlement information on the commodity subjected to the settlement processing performed by the checkout machine 3, and manages sales of the store. If the commodity information is transmitted to the checkout machine 3 via the server 5, the server 5 stores the commodity information received from the registration machine 1 by correlating the commodity information with, for example, management information (for example, a temporary receipt number for identifying a transaction, and customer identification information for identifying a customer) which is simultaneously received. Upon receiving the management information from the checkout machine 3, the server 5 transmits the commodity information correlated with the management information to the checkout machine 3.

During checkout performed in the checkout machine 3, the customer may cancel a part or all of the commodities subjected to the commodity registration processing. For example, if the customer remembers that a part of the commodities are already purchased, a cancellation operation of the purchase of the commodities is performed before the checkout operation. The customer located at the position W performs the cancellation operation on the checkout machine 3. If the customer performs the cancellation operation, the checkout machine 3 transmits, to the registration machine 1, cancellation information indicating that the registration machine 1 is requested to cancel the commodity.

If the registration machine 1 ends the commodity registration processing of a preceding customer and transmits the commodity information to the checkout machine 3, the commodity registration processing of a next customer is possible. The store clerk operates the registration machine 1 to start the commodity registration processing of the next customer. If the cancellation information on the preceding customer is received from the checkout machine 3 in this state (that is, during the commodity registration for the next customer), the registration machine 1 displays, on the store clerk display unit 18, a message indicating that the preceding customer requests the cancellation of the commodity (cancellation of the commodity registration processing) even though the commodity registration for the next customer is being performed. By viewing the display, the store clerk recognizes that the preceding customer requests the cancellation of the commodity.

The registration machine 1 displays a selection screen for selecting whether to perform the cancellation operation of the preceding customer using the registration machine 1 or using the checkout machine 3. The store clerk operates the selection screen to select whether to perform the cancellation operation using the registration machine 1 or using the checkout machine 3. For example, when the cancellation operation of the preceding customer is performed in the registration machine 1, since the store clerk performs the commodity registration operation of the next customer using the registration machine 1, the cancellation operation of the preceding customer can be performed on the spot (without moving to the checkout machine 3). If the cancellation operation of the preceding customer is performed using the checkout machine 3, the store clerk can perform the cancellation operation of the preceding customer in the presence of the preceding customer, and thus, it is possible to give a sense of security to the preceding customer. If the cancellation operation of the preceding customer is performed using the checkout machine 3, the store clerk can easily (on the spot) receive the cancelled commodity from the preceding customer.

If it is selected to perform the cancellation operation using the registration machine 1, the registration machine 1 receives the commodity information on the commodity subjected to the commodity registration processing from the checkout machine 3. The store clerk interrupts the commodity registration operation of the next customer in the registration machine 1 and designates one or a plurality of commodities to be cancelled. The registration machine 1 transmits the designated commodity information (cancellation information) to the checkout machine 3.

If it is selected to perform the cancellation operation using the checkout machine 3, the registration machine 1 transmits, to the checkout machine 3, cancellation registration information indicating that the cancellation operation is performed using the checkout machine 3. The store clerk interrupts the commodity registration operation of the next customer in the registration machine 1, goes to the checkout machine 3, and designates one or more commodities to be cancelled using the checkout machine 3.

The checkout machine 3 executes cancellation processing of the commodity based on the cancellation information received from the registration machine 1. If the cancellation registration information is received from the registration machine 1, the checkout machine 3 executes the cancellation processing of the commodity designated by the operation of the store clerk in the checkout machine 3. The cancellation processing is processing of deleting the commodity information on a commodity to be cancelled from commodities stored in the commodity information unit 331 (commodities subjected to the commodity registration processing using the registration machine 1).

If the cancellation processing related to the preceding customer is completed, the checkout machine 3 transmits cancellation completion information to the registration machine 1. Upon receiving the cancellation completion information from the checkout machine 3, the registration machine 1 can resume the interrupted commodity registration operation of the next customer. If the cancellation processing related to the preceding customer is completed, the checkout machine 3 executes the settlement processing on the commodities except for the commodities subjected to the cancellation processing among the commodities subjected to the commodity registration processing (commodities related to the commodity information stored in the commodity information unit 331 after the cancellation processing).

Next, a hardware configuration of the registration machine 1 will be described. FIG. 3 is a block diagram showing a hardware configuration of the registration machine 1. As shown in FIG. 3, the registration machine 1 includes a central processing unit (CPU) 11, which is an example of a processor, a read-only memory (ROM) 12, a random access memory (RAM) 13, a memory unit 14, and the like. The CPU 11 is a control entity. The ROM 12 stores various programs. The RAM 13 loads various types of data. The memory unit 14 stores various programs. The CPU 11, the ROM 12, the RAM 13, and the memory unit 14 are connected to one another via a data bus 15. The CPU 11, the ROM 12, and the RAM 13 constitute a control unit 100. That is, the CPU 11 operates according to a control program that is stored in the ROM 12 or the memory unit 14 and loaded into the RAM 13, and thus the control unit 100 performs control processing of the registration machine 1 to be described later.

The RAM 13 includes a commodity information unit 131, a cancelled commodity unit 132, and an interruption information unit 133. The commodity information unit 131 stores the commodity information on the commodity subjected to the commodity registration processing. The cancelled commodity unit 132 stores the commodity identification information on the commodity for which the cancellation is operated in the registration machine 1. When the cancellation operation of the preceding customer is performed, the interruption information unit 133 saves and stores the commodity information related to commodities that are already registered for the next customer, which is already started.

The memory unit 14 is implemented by a nonvolatile memory such as a hard disc drive (HDD) or a flash memory in which stored information is held even when a power supply is turned off. The memory unit 14 includes a control program unit 141 that stores a control program. The memory unit 14 includes a commodity master 142. The commodity master 142 stores commodity information such as a commodity name, a price (unit price), and an attribute of the commodity for each commodity identification information for identifying the commodity.

The control unit 100 is connected to an operation unit 17, the store clerk display unit 18, the customer display unit 19, the code reading unit 20, and a card reading unit 21 via the data bus 15 and a controller 16.

The operation unit 17 includes a touch panel provided on the store clerk display unit 18, and includes a subtotal key 171, a transmission key 172, a registration machine key 173, and a checkout machine key 174. The subtotal key 171 is operated by the store clerk when the commodity registration processing in the registration machine 1 is completed. The transmission key 172 is operated by the store clerk when the commodity information (the commodity information stored in the commodity information unit 131) of the commodity subjected to the commodity registration is transmitted to the checkout machine 3. The registration machine key 173 is operated by the store clerk if an operation of selecting a commodity to be cancelled is performed using the registration machine 1. The checkout machine key 174 is operated by the store clerk if the operation of selecting a commodity to be cancelled is performed using the checkout machine 3. The registration machine key 173 and the checkout machine key 174 at least are keys on the touch panel provided on the store clerk display unit 18. In the following description, a description of “key provided on the operation unit 17 corresponding to a display of the key on the store clerk display unit 18” may be simplified as, for example, “key displayed on the store clerk display unit 18”.

The store clerk display unit 18 displays (notifies) information to the store clerk located at the position M. The customer display unit 19 displays (notifies) information to the customer located at the position V. The code reading unit 20 images the commodities scanned by the store clerk. The card reading unit 21 reads the customer identification information (for example, a customer code or a customer number) for identifying a customer from a medium such as a customer card.

The control unit 100 is connected to a communication unit 22 via the data bus 15. The communication unit 22 is connected to the checkout machine 3 and the server 5 via the communication line L so that information can be transmitted and received.

FIG. 4 is a block diagram showing a hardware configuration of the checkout machine 3. As shown in FIG. 4, the checkout machine 3 includes a CPU 31, which is an example of a processor, a ROM 32, a RAM 33, a memory unit 34, and the like. The CPU 31 is a control entity. The ROM 32 stores various programs. The RAM 33 loads various types of data. The memory unit 34 stores various programs. The CPU 31, the ROM 32, the RAM 33, and the memory unit 34 are connected to one another via a data bus 35. The CPU 31, the ROM 32, and the RAM 33 constitute a control unit 300. That is, the CPU 31 operates according to a control program that is stored in the ROM 32 or the memory unit 34 and loaded into the RAM 33, and thus the control unit 300 performs control processing of the checkout machine 3 to be described later.

The RAM 33 includes the commodity information unit 331, a cancelled commodity unit 332, and a checkout information unit 333. The commodity information unit 331 stores the commodity information on the commodity subjected to the commodity registration processing received from the registration machine 1. The cancelled commodity unit 332 stores the commodity identification information on the commodity for which the cancellation operation is performed using the checkout machine 3. The checkout information unit 333 stores the commodity information and the settlement information (collectively referred to as “sales information”) of the commodity subjected to the settlement processing.

The memory unit 34 includes a nonvolatile memory such as an HDD or a flash memory in which stored information is held even when the power supply is turned off. The memory unit 34 includes a control program unit 341 that stores a control program.

The control unit 300 is connected to the operation unit 37, the store clerk display unit 38, the customer display unit 39, the printing unit 40, the card reading unit 41, the handy scanner 42, and the coin machine 43 via the data bus 35 and a controller 36.

The operation unit 37 includes a checkout key 371 and a cancel key 372. The checkout key 371 and the cancel key 372 are keys provided on a touch panel provided on the customer display unit 39. The checkout key 371 is operated by the customer if the settlement processing is performed on the commodity subjected to the commodity registration processing. The cancel key 372 is operated by the customer if a part or all of commodities subjected to the commodity registration processing is cancelled (cancellation of the commodity registration) before the settlement processing is performed. The cancel key 372 is a cancel declaration key operated to cancel the commodity subjected to the commodity registration.

The store clerk display unit 38 displays (notifies) information to the store clerk located at the position N. The customer display unit 39 displays (notifies) information to the customer located at the position W. The printing unit 40 dispenses, to the customer, a receipt on which the commodity information and the settlement information related to the commodity subjected to the settlement processing are printed. The card reading unit 41 is operated if the customer performs the settlement processing on a medium other than cash. The handy scanner 42 is operated by the store clerk when, for example, registering an additional commodity such as a forgotten commodity. The coin machine 43 is used when the customer deposits cash during the settlement processing. The coin machine 43 dispenses coins to the customer.

The control unit 300 is connected to a communication unit 44 via the data bus 35. The communication unit 44 is connected to the registration machine 1 and the server 5 via the communication line L so that information can be transmitted and received.

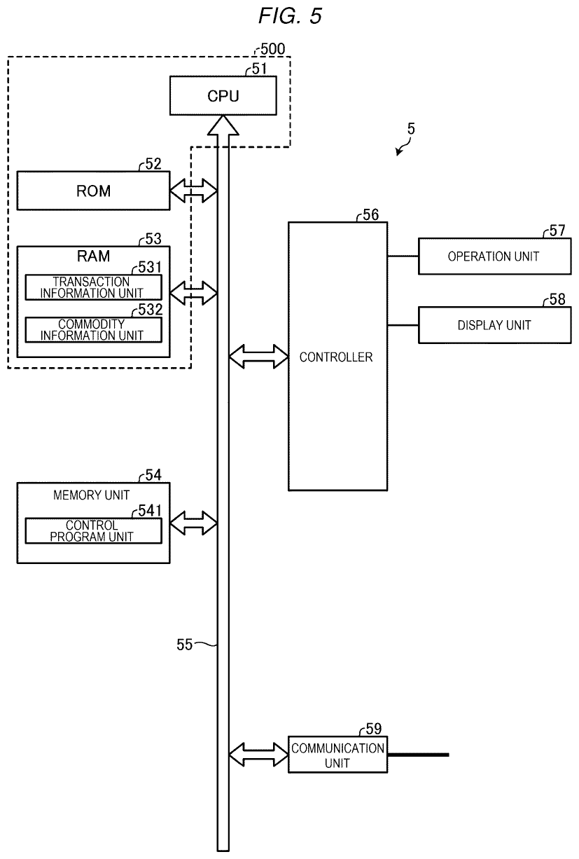

FIG. 5 is a block diagram showing a hardware configuration of the server 5. As shown in FIG. 5, the server 5 includes a CPU 51, which is an example of a processor, a ROM 52, a RAM 53, a memory unit 54, and the like. The CPU 51 is a control entity. The ROM 52 stores various programs. The RAM 53 loads various types of data. The memory unit 54 stores various programs. The CPU 51, the ROM 52, the RAM 53, and the memory unit 54 are connected to one another via a data bus 55. The CPU 51, the ROM 52, and the RAM 53 constitute a control unit 500. That is, the CPU 51 operates according to a control program that is stored in the ROM 52 or the memory unit 54 and loaded into the RAM 53, and thus the control unit 500 performs control processing of the server 5.

The RAM 53 includes a transaction information unit 531 and a commodity information unit 532. The transaction information unit 531 collects the sales information on the commodities subjected to the settlement processing in the checkout machine 3 from each checkout machine 3, and accumulates and stores the sales information. The commodity information unit 532 stores the commodity information received from the registration machine 1 when the commodity information on the commodities subjected to the commodity registration processing is not directly transmitted from the registration machine 1 to the checkout machine 3 but is transmitted from the registration machine 1 to the checkout machine 3 via the server 5. In response to a request from the checkout machine 3, the server 5 transmits the commodity information stored in the commodity information unit 532 to the checkout machine 3 that makes the request.

The memory unit 54 includes a nonvolatile memory such as an HDD or a flash memory in which stored information is held even when the power supply is turned off. The memory unit 54 includes a control program unit 541 that stores a control program.

The control unit 500 is connected to an operation unit 57 and a display unit 58 via the data bus 55 and a controller 56. The operation unit 57 is operated by an operator of the server 5. The display unit 58 displays information for the operator of the server 5.

The control unit 500 is connected to a communication unit 59 via the data bus 55. The communication unit 59 is connected to the checkout machine 3 and the registration machine 1 via the communication line L so that information can be transmitted and received.

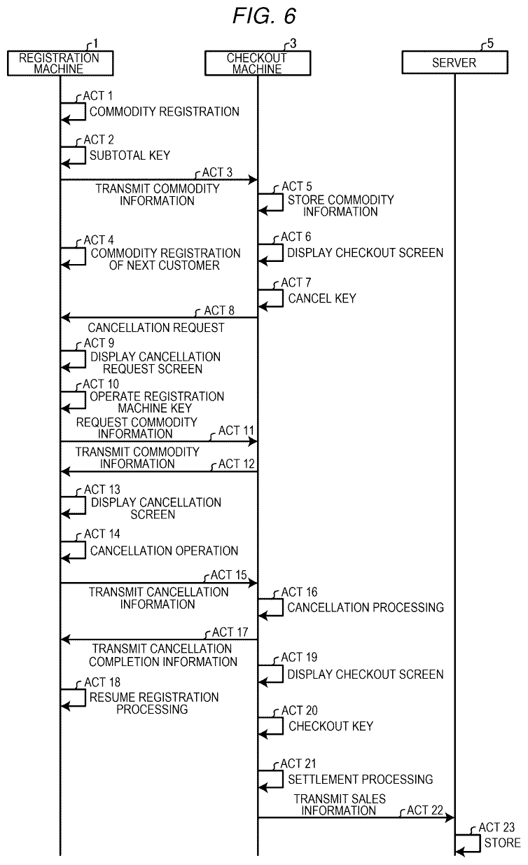

Hereinafter, data and a flow of processing in the sales data processing system 10 will be described. FIG. 6 is a sequence diagram showing the data and the flow of processing in the sales data processing system 10 if the cancellation operation is performed using the registration machine 1. A customer who performs the commodity registration first is referred to as a “preceding customer”, and a customer who performs the commodity registration next to the preceding customer is referred to as a “next customer”. As shown in FIG. 6, the registration machine 1 performs the commodity registration processing of the preceding customer in response to the commodity registration operation of the store clerk (ACT 1). Further, if the commodity registration processing of all the commodities purchased by the preceding customer is completed, the store clerk operates the subtotal key 171 (ACT 2). If the subtotal key 171 is operated, the registration machine 1 transmits, to the checkout machine 3, the commodity information on the preceding customer related to the commodities subjected to the commodity registration (ACT 3). Then, the registration machine 1 starts the commodity registration processing of the next customer in response to the commodity registration operation of the store clerk (ACT 4).

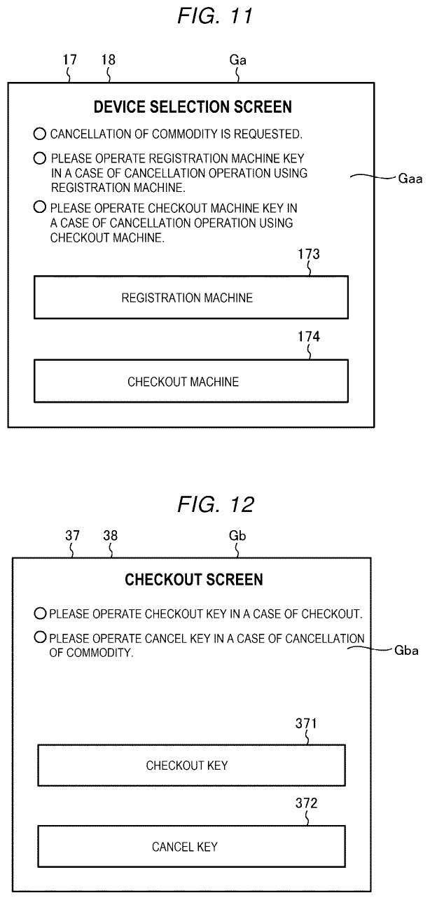

The checkout machine 3 stores, in the commodity information unit 331, the commodity information on the preceding customer received from the registration machine 1 (ACT 5). Then, the checkout machine 3 displays a checkout screen (see FIG. 11) for starting the checkout of the preceding customer (ACT 6). If the commodity registration of one or a plurality of commodities is cancelled at this stage where the checkout is not performed yet, the customer operates the cancel key 372 (ACT 7). If the cancel key 372 is operated, the checkout machine 3 transmits, to the registration machine 1, cancellation request information indicating that the cancellation of the commodity requested by the preceding customer is requested (ACT 8). The registration machine 1 that receives the cancellation request information displays a cancellation request screen (see FIG. 12) (ACT 9). The cancellation request screen displays a message indicating that the preceding customer requests for the cancellation of the commodity, the registration machine key 173 (option) operated when the cancellation operation is performed using the registration machine 1, and the checkout machine key 174 (option) operated when the cancellation operation is performed using the checkout machine 3.

The store clerk operates the registration machine key 173 when performing the cancellation operation of the preceding customer using the registration machine 1, and operates the checkout machine key 174 when performing the cancellation operation of the preceding customer using the checkout machine 3. The registration machine key 173 is operated by the store clerk (ACT 10). Then, the registration machine 1 interrupts the commodity registration processing of the next customer started at ACT 4 and requests the checkout machine 3 to transmit the commodity information on the preceding customer transmitted at ACT 3 (ACT 11). Further, the registration machine 1 receives the commodity information from the checkout machine 3 (ACT 12). If the commodity information on the preceding customer transmitted by the registration machine 1 at ACT 3 is stored in the RAM 13 or the memory unit 14, the processing of ACT 11 and the processing of ACT 12 are unnecessary.

The registration machine 1 displays on the store clerk display unit 18, based on the received commodity information on the preceding customer, a cancellation screen including a list of commodities purchased by the preceding customer (ACT 13). The store clerk performs, based on the displayed cancellation screen, the cancellation operation on the commodity to be cancelled (ACT 14). The cancellation operation is, for example, an operation in which the store clerk designates a commodity to be cancelled by touching a display position of the commodity to be cancelled on the touch panel (the operation unit 17) provided on the store clerk display unit 18. The cancellation operation may be an operation of designating a commodity to be cancelled by checking the displayed commodity and images the commodity to be cancelled (received from the customer) using the code reading unit 20.

The registration machine 1 transmits, to the checkout machine 3, the cancellation information including commodity identification information identifying the commodity designated by the cancellation operation (ACT 15). The checkout machine 3 that receives the cancellation information performs the cancellation processing of the commodity (ACT 16). The cancellation processing is processing of deleting the commodity information on the commodity included in the cancellation information from the commodity information stored in the commodity information unit 331. Further, the checkout machine 3 transmits, to the registration machine 1, the cancellation completion information indicating that the cancellation processing of the commodity is performed (ACT 17). The registration machine 1 receiving the cancellation completion information can resume the commodity registration processing of the next customer interrupted in ACT 11 (ACT 18).

The checkout machine 3 that transmits the cancellation completion information at ACT 17 displays the checkout screen displayed at ACT 6 (ACT 19). The preceding customer operates the checkout key 371 (ACT 20). Then, the checkout machine 3 executes the settlement processing based on the commodity information stored in the commodity information unit 331 (ACT 21). Further, the checkout machine 3 transmits, to the server 5, the sales information on the commodity subjected to the settlement processing (ACT 22). The server 5 cumulatively stores the sales information received from the checkout machine 3 in the transaction information unit 531 (ACT 23).

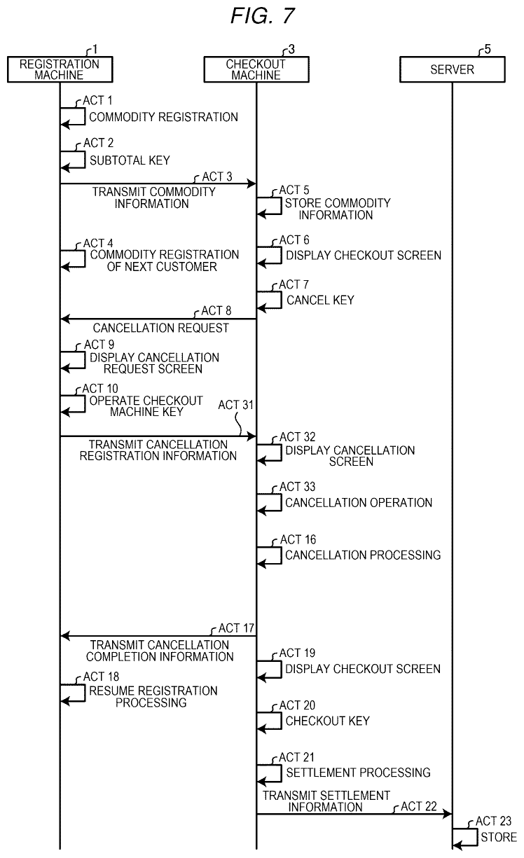

FIG. 7 is a sequence diagram showing the data and the flow of processing in the sales data processing system 10 if the cancellation operation is performed using the checkout machine 3. The data and the flow of processing same as those in FIG. 6 are denoted by the same reference numerals as those in FIG. 6, description thereof will be simplified or omitted, and a flow different from that in FIG. 6 will be mainly described.

ACT 1 to ACT 9 are the same processing as those in FIG. 6. Further, the checkout machine key 174 is operated by the store clerk (ACT 10). Then, the registration machine 1 interrupts the commodity registration processing of the next customer started at ACT 4, and transmits, to the checkout machine 3, the cancellation registration information indicating that the cancellation operation is performed using the checkout machine 3 (ACT 31). The checkout machine 3 receiving the cancellation registration information displays, on the store clerk display unit 38, a cancellation screen including a list of commodities purchased by the preceding customer (ACT 32). The store clerk who moves from the registration machine 1 (the position M) to the checkout machine 3 (the position N) performs, based on the cancellation screen displayed on the store clerk display unit 38, the cancellation operation of designating a commodity to be cancelled using the touch panel (a part of the operation unit 37) provided on the store clerk display unit 38 (ACT 33). The cancellation operation is, for example, an operation in which the store clerk designates a commodity to be cancelled by touching a display position of the commodity to be cancelled on the touch panel (the operation unit 37) provided on the store clerk display unit 38. The cancellation operation may be an operation of designating a commodity to be cancelled by checking the displayed commodity and images the commodity to be cancelled (received from the customer) using the handy scanner 42. If the cancellation operation is performed by the store clerk, the checkout machine 3 performs the cancellation processing of the commodity (ACT 16). Thereafter, ACT 17 to ACT 23 are the same processing as those in FIG. 6.

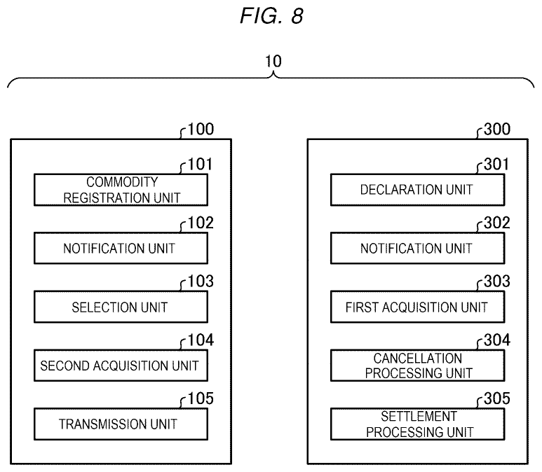

Hereinafter, a functional configuration of the sales data processing system 10 will be described. FIG. 8 is a functional block diagram showing functional configurations of the registration machine 1 and the checkout machine 3.

The control unit 100 of the registration machine 1 functions as a commodity registration unit 101, a notification unit 102, a selection unit 103, a second acquisition unit 104, and a transmission unit 105 by following a control program stored in the ROM 12 or the control program unit 141 of the memory unit 14.

The commodity registration unit 101 performs the commodity registration processing of the commodities purchased by the customer based on the operation of the store clerk. Specifically, the commodity registration unit 101 performs the commodity registration processing on the commodities purchased by the customer and imaged by the code reading unit 20 by the store clerk.

The notification unit 102 notifies the store clerk of the cancellation of the commodity. Specifically, if the notification unit 102 receives the notification of the cancellation request information on the commodity transmitted from the checkout machine 3, the notification unit 102 notifies the store clerk of the cancellation of the commodity performed by the preceding customer (that the preceding customer requests the cancellation of the commodity).

The selection unit 103 selects whether the cancellation operation is performed using the registration machine 1 or using the checkout machine 3. Specifically, the selection unit 103 selects, based on whether the registration machine key 173 or the checkout machine key 174 is operated, whether the cancellation operation is performed using the registration machine 1 or using the checkout machine 3. The selection unit 103 selects to perform the cancellation operation using the registration machine 1 if the registration machine key 173 is operated, and selects to perform the cancellation operation using the checkout machine 3 if the checkout machine key 174 is operated.

The second acquisition unit 104 acquires information on a commodity to be cancelled. Specifically, if the selection unit 103 selects to perform the cancellation operation using the registration machine 1, the second acquisition unit 104 acquires information on the commodity to be cancelled.

The transmission unit 105 transmits, to the checkout machine 3, the cancellation information including the information on the commodity to be cancelled (the commodity identification information) acquired by the second acquisition unit 104.

The control unit 300 of the checkout machine 3 functions as a declaration unit 301, a notification unit 302, a first acquisition unit 303, a cancellation processing unit 304, and a settlement processing unit 305 by following a control program stored in the ROM 32 or the control program unit 341 of the memory unit 34.

The declaration unit 301 receives a declaration of cancellation of a part or all of the commodities subjected to the commodity registration processing. Specifically, if the cancel key 372 is operated, the declaration unit 301 receives a declaration of cancellation of a part or all of the commodities subjected to the commodity registration processing.

The notification unit 302 notifies the registration machine 1 of the cancellation of the commodity by the declaration unit 301. Specifically, if the cancel key 372 is operated, the notification unit 302 transmits the cancellation request information to the registration machine 1.

The first acquisition unit 303 acquires information on the commodity to be cancelled, which is designated based on the operation of the store clerk. Specifically, the first acquisition unit 303 stores, in the cancelled commodity unit 332, the cancellation information including the commodity identification information on the commodity to be cancelled, which is designated by the store clerk operating the operation unit 37. The first acquisition unit 303 receives, from the registration machine 1, the cancellation information including the cancellation information on a commodity to be cancelled, which is designated by the store clerk operating the operation unit 17, and stores the cancellation information in the cancelled commodity unit 332.

The cancellation processing unit 304 performs the cancellation processing of a commodity whose information is acquired by the first acquisition unit 303 among commodities subjected to the commodity registration processing.

The settlement processing unit 305 performs, based on the operation of the customer, the settlement processing of commodities subjected to the commodity registration processing using the registration machine 1 except for the commodity cancelled by the cancellation processing unit 304.

Hereinafter, control processing of the registration machine 1 according to the sales data processing system 10 in the embodiment will be described. The control unit 100 of the registration machine 1 executes the control processing according to the control program stored in the ROM 12 or the control program unit 141.

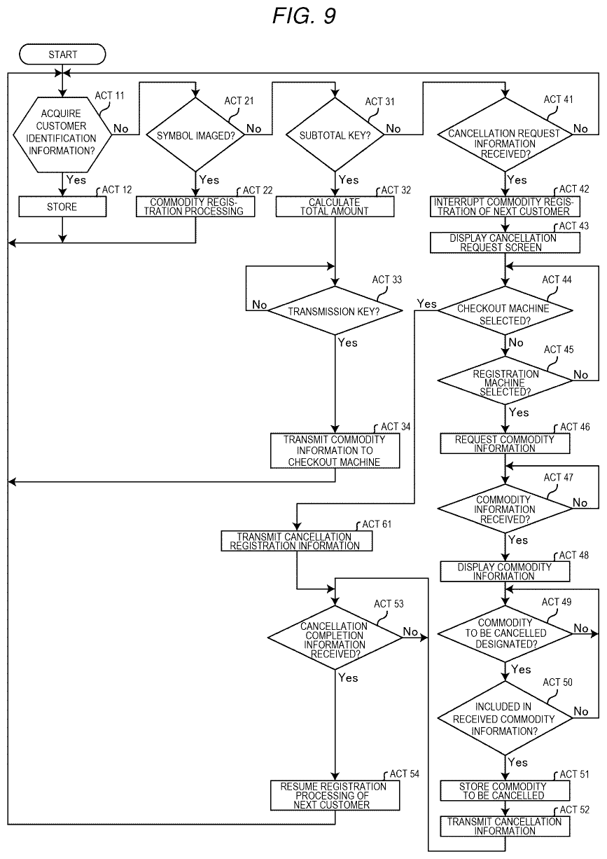

FIG. 9 is a flowchart showing a flow of the control processing performed in the registration machine 1. As shown in FIG. 9, the control unit 100 of the registration machine 1 determines whether the customer identification information is read by the code reading unit 20 (ACT 11). If it is determined that the customer identification information is read (Yes in ACT 11), the control unit 100 stores the customer identification information in the RAM 13 (ACT 12). Further, the control unit 100 returns the processing to ACT 11.

If it is determined that the customer identification information is not read (No in ACT 11), the control unit 100 determines whether a symbol attached to the commodity is imaged by the code reading unit 20 (ACT 21). If it is determined that the symbol is imaged (Yes in ACT 21), the commodity registration unit 101 acquires a commodity code which is the commodity identification information corresponding to the imaged symbol, reads the commodity information on the commodity identified by the commodity code from the commodity master 142, and stores the commodity information in the commodity information unit 131 (ACT 22). Further, the control unit 100 returns the processing to ACT 11.

If it is determined that the symbol is not imaged (No in ACT 21), the control unit 100 determines whether the subtotal key 171 is operated (ACT 31). If it is determined that the subtotal key 171 is operated (Yes in ACT 31), the control unit 100 calculates a total amount of the transaction based on the commodity information stored in the commodity information unit 131 (ACT 32). The total amount is displayed on the store clerk display unit 18 and the customer display unit 19.

Next, the control unit 100 determines whether the transmission key 172 is operated (ACT 33). The control unit 100 waits until the transmission key 172 is operated (No in ACT 33). If it is determined that the transmission key 172 is operated (Yes in ACT 33), the control unit 100 transmits the commodity information stored in the commodity information unit 131 to the checkout machine 3 (ACT 34). Further, the control unit 100 returns the processing to ACT 11. If the commodity information is transmitted to the server 5, if the transmission key 172 is operated, the control unit 100 dispenses a slip on which a transaction number identifying the transaction is symbolized and printed. In ACT 34, the control unit 100 transmits the commodity information stored in the commodity information unit 131 to the server 5 together with transaction information. Further, the control unit 100 returns the processing to ACT 11.

If it is determined that the subtotal key 171 is not operated (No in ACT 31), the control unit 100 determines whether the cancellation request information is received from the checkout machine 3 (ACT 41). When it is determined that the cancellation request information is not received (No in ACT 41), the processing returns to ACT 11. If it is determined that the cancellation request information is received (Yes in ACT 41), the control unit 100 stores (saves) from the commodity information unit 131 to the interruption information unit 133, the commodity information which is already subjected to the commodity registration processing up to that point for the next customer who starts the commodity registration processing, and interrupts the commodity registration of the next customer (ACT 42). Next, the notification unit 102 displays the cancellation request screen on the store clerk display unit 18 (ACT 43). The cancellation request screen is a screen for notifying the store clerk who operates the registration machine 1 that there is a cancellation request including a message indicating that the preceding customer requests for the cancellation of the commodity in the checkout machine 3. The store clerk views the displayed cancellation request screen and recognizes that the cancellation request is made in the checkout machine 3.

FIG. 11 shows an example of the cancellation request screen Ga displayed in ACT 43. As shown in FIG. 11, the store clerk display unit 18 displays the cancellation request screen Ga indicating that the cancellation request by the customer (the preceding customer) is made from the checkout machine 3. The cancellation request screen Ga displays a message Gaa that indicates that the cancellation request is made by the customer (the preceding customer) who operates the checkout machine 3 and prompts the store clerk to perform the cancellation operation using the registration machine 1 or the checkout machine 3. The cancellation request screen Ga displays images of keys indicating the registration machine key 173 and the checkout machine key 174 at positions facing the respective keys. The store clerk operates the registration machine key 173 if the cancellation operation is performed using the registration machine 1. The store clerk operates the checkout machine key 174 if the cancellation operation is performed using the checkout machine 3.

Referring back to FIG. 9. Next, the selection unit 103 selects whether the cancellation operation is performed using the registration machine 1 or using the checkout machine 3. That is, the control unit 100 determines whether the checkout machine key 174 is operated (ACT 44). If it is determined that the checkout machine key 174 is not operated, the control unit 100 determines whether the registration machine key 173 is operated (ACT 45). The selection unit 103 selects whether to perform the cancellation operation using the registration machine 1 or the cancellation operation using the checkout machine 3 according to the determination in ACT 44 and the determination in ACT 45 performed by the control unit 100.

If it is determined that the registration machine key 173 is not operated (No in ACT 45), the control unit 100 returns the processing to ACT 44. If it is determined that the registration machine key 173 is operated (Yes in ACT 45), the control unit 100 requests the commodity information on the preceding customer from the checkout machine 3 (ACT 46). Next, the control unit 100 determines whether the commodity information on the preceding customer (including the commodity identification information) is received from the checkout machine 3 (ACT 47). The control unit 100 waits until the commodity information on the preceding customer is received (No in ACT 47), and if it is determined that the commodity information on the preceding customer is received (Yes in ACT 47), the control unit 100 displays the received commodity information on the preceding customer in a list (that is, displays a list including commodity names of the commodities subjected to the commodity registration processing) (ACT 48).

The store clerk views the displayed commodity names and performs a touch operation on the commodity desired by the preceding customer. Then, the commodity desired to be cancelled by the preceding customer is designated. The store clerk may designate the commodity to be cancelled by reading the symbol attached to the commodity desired to be cancelled by the preceding customer by the code reading unit 20. The control unit 100 determines whether the commodity to be cancelled is designated (ACT 49). The control unit 100 waits until the commodity to be cancelled is designated (No in ACT 49), and if it is determined that the commodity to be cancelled is designated (Yes in ACT 49), the control unit 100 determines whether the commodity information on the designated commodity is included in the received commodity information (ACT 50). The determination in ACT 50 is performed to determine whether the designated commodity to be cancelled is included in the commodities subjected to the commodity registration processing. For example, if the commodity to be cancelled is designated by reading a symbol attached to the commodity by the code reading unit 20, it is necessary to determine whether the commodity is subjected to the commodity registration processing. If it is determined that the designated commodity is not included in the commodities subjected to the commodity registration processing (No in ACT 50), the control unit 100 returns the processing to ACT 49 since the commodity cannot be cancelled, and designates the commodity to be cancelled again. If it is determined that the designated commodity is included in the commodities subjected to the commodity registration processing (Yes in ACT 50), the second acquisition unit 104 acquires information on the commodity to be cancelled (ACT 51). That is, the second acquisition unit 104 stores the commodity identification information related to the designated commodity to be cancelled in the cancelled commodity unit 132 (ACT 51). Further, the transmission unit 105 transmits, to the checkout machine 3, the cancellation information including the commodity identification information on the commodity to be cancelled stored in the cancelled commodity unit 132 (ACT 52).

Next, the control unit 100 determines whether the cancellation completion information is received from the checkout machine 3 (ACT 53). The control unit 100 waits until the cancellation completion information is received (No in ACT 53), and if it is determined that the cancellation completion information is received (Yes in ACT 53), the control unit 100 calls the commodity information on the next customer stored in the interruption information unit 133 and stores the commodity information in the commodity information unit 131, so that the commodity registration processing of the next customer interrupted in ACT 42 can be resumed (ACT 54). Further, the control unit 100 returns the processing to ACT 11.

If it is determined in ACT 44 that the checkout machine key 174 is operated (Yes in ACT 44), the control unit 100 transmits, to the checkout machine 3, the cancellation registration information indicating that the cancellation operation is performed using the checkout machine 3 (ACT 61). Further, the control unit 100 executes the determination in ACT 53 and the processing of ACT 54. Further, the control unit 100 returns the processing to ACT 11.

If the registration machine 1 according to the embodiment receives the cancellation request information from the checkout machine 3, the registration machine 1 can notify the store clerk of the cancellation request from the preceding customer and can select a device (the registration machine 1 or the checkout machine 3) to perform the cancellation operation. If the registration machine 1 is selected, the commodity to be cancelled can be designated from the registration machine 1.

Hereinafter, control processing of the checkout machine 3 according to the sales data processing system 10 in the embodiment will be described. The control unit 300 of the checkout machine 3 executes the control processing according to the control program stored in the ROM 32 or the control program unit 341.

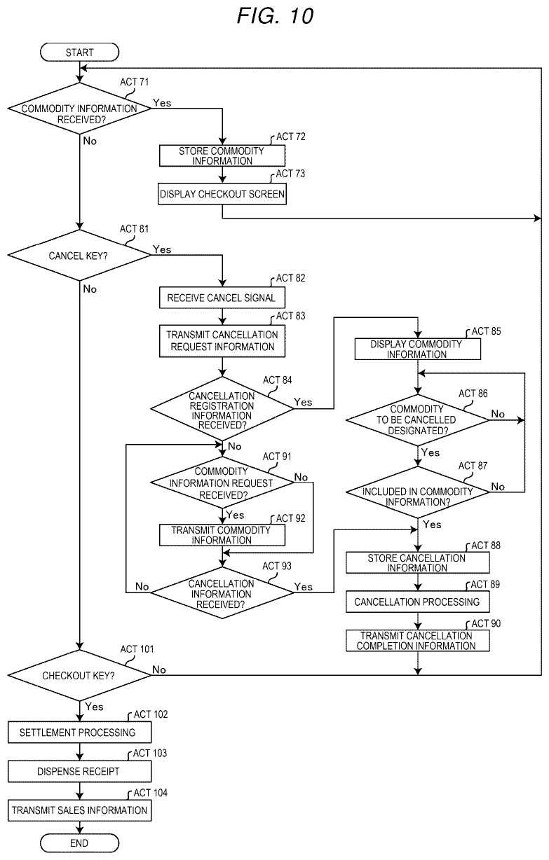

FIG. 10 is a flowchart showing a flow of the control processing performed in the checkout machine 3. As shown in FIG. 10, the control unit 300 of the checkout machine 3 determines whether the commodity information is received from the registration machine 1 (ACT 71). If it is determined that the commodity information is received (Yes in ACT 71), the control unit 300 stores the received commodity information in the commodity information unit 331 (ACT 72). Then, the control unit 300 displays the checkout screen on the customer display unit 39 (ACT 73). Further, the control unit 300 returns the processing to ACT 71.

FIG. 12 shows an example of a checkout screen Gb displayed in ACT 73. The checkout screen Gb is displayed on the customer display unit 39. The checkout screen Gb displays an operation description Gba for a case in which the checkout is performed and a case in which the cancellation is performed, an image of the checkout key 371 operated by the customer to shift to the checkout, and an image of the cancel key 372 operated by the customer to request the cancellation of the commodity subjected to the commodity registration. The customer operates the checkout key 371 in the case of proceeding to the checkout, and operates the cancel key 372 in the case of requesting the cancellation.

The description returns to FIG. 10. If it is determined that the commodity information is not received from the registration machine 1 (No in ACT 71), the control unit 300 determines whether the cancel key 372 is operated (ACT 81). If it is determined that the cancel key 372 is operated (Yes in ACT 81), the declaration unit 301 receives a signal indicating that the cancel key 372 is operated (ACT 82). That is, the declaration unit 301 receives a declaration of cancellation of a part or all of the commodities subjected to the commodity registration processing. Further, the notification unit 302 transmits the cancellation request information to the registration machine 1 (ACT 83).

Next, the control unit 300 determines whether the cancellation registration information is received from the registration machine 1 (ACT 84). If it is determined that the cancellation registration information is received (Yes in ACT 84), the control unit 300 displays, based on the commodity information stored in the commodity information unit 331, the commodity information in a list (that is, displays a list including the commodity names of the commodities subjected to the commodity registration processing) (ACT 85). The display is equivalent to the screen displayed by the registration machine 1 in ACT 48.

The store clerk views the displayed commodity names and performs a touch operation on the commodity desired by the preceding customer. Then, the commodity desired to be cancelled by the preceding customer is designated. The commodity to be cancelled may be designated by reading the symbol attached to the commodity desired by the preceding customer with the handy scanner 42. The control unit 300 determines whether the commodity to be cancelled is designated (ACT 86). The The control unit 300 waits until the commodity to be cancelled is designated (No in ACT 86), and if it is determined that the commodity to be cancelled is designated (Yes in ACT 86), the control unit 300 determines whether the designated commodity is included in the commodities displayed in ACT 85 (ACT 87). The determination in ACT 87 is performed to determine whether the designated commodity is included in the commodities subjected to the commodity registration processing. For example, if the commodity to be cancelled is designated by reading a symbol attached to the commodity by the handy scanner 42, it is necessary to determine whether the commodity is subjected to the commodity registration processing. If it is determined that the designated commodity is not included in the commodities subjected to the commodity registration processing (No in ACT 87), the control unit 300 returns the processing to ACT 86 since the commodity cannot be cancelled, and designates the commodity to be cancelled again. If it is determined that the designated commodity is included in the commodities subjected to the commodity registration processing (Yes in ACT 87), the first acquisition unit 303 acquires information on the commodity to be cancelled (ACT 88). That is, the first acquisition unit 303 stores the commodity identification information related to the designated commodity to be cancelled in the cancelled commodity unit 332 (ACT 88). Then, the cancellation processing unit 304 executes the cancellation processing of deleting, from the commodity information unit 331, the commodity identification information on the commodity to be cancelled stored in the cancelled commodity unit 332 (ACT 89). Further, the control unit 300 transmits, to the registration machine 1, the cancellation completion information indicating that the commodity is cancelled (ACT 90). Further, the control unit 300 returns the processing to ACT 71.

If it is determined that the cancellation registration information is not received (No in ACT 84), the control unit 300 determines whether request information on the commodity information is received from the registration machine 1 (ACT 91). If it is determined that the request information on the commodity information is received (Yes in ACT 91), the control unit 300 transmits, to the registration machine 1, the commodity information stored in the commodity information unit 331 (ACT 92). Next, the control unit 300 determines whether the cancellation information is received from the registration machine 1 (ACT 93). If it is determined that the cancellation information is received (Yes in ACT 93), the first processing unit 303 stores, in the cancelled commodity unit 332, the commodity identification information included in the received cancellation information (ACT 88). Then, the cancellation processing unit 304 deletes the commodity identification information stored in the cancelled commodity unit 332 from the commodity information unit 331 (ACT 89). Then, the control unit 300 executes the processing of ACT 90.

If it is determined that the request information on the commodity information is not received (No in ACT 91), the control unit 300 performs the determination in ACT 93 without executing the processing in ACT 92. If it is determined that the cancellation information is not received (No in ACT 93), the control unit 300 returns the processing to ACT 91.

If it is determined in ACT 81 that the cancel key 372 is not operated (No in ACT 81), the control unit 300 determines whether the checkout key 371 is operated (ACT 101) If it is determined that the checkout key 371 is not operated (No in ACT 101), the processing returns to ACT 71. If it is determined that the checkout key 371 is operated (Yes in ACT 101), the settlement processing unit 305 executes the settlement processing based on the commodity information stored in the commodity information unit 331 (ACT 102). Then, the control unit 300 uses the printing unit 40 to dispense a receipt on which the commodity information on the commodity subjected to the settlement processing and the settlement information are printed (ACT 103). Further, the control unit 300 transmits, to the server 5, the sales information including the commodity information on the commodity subjected to the settlement processing and the settlement information (ACT 104). Then, the control unit 300 ends the processing.

The checkout machine 3 according to the embodiment can designate the commodity to be cancelled when the customer (the preceding customer) requests the cancellation of the commodity subjected to the commodity registration processing. The checkout machine 3 can execute cancellation processing of the designated commodity or the commodity designated by the registration machine 1. The checkout machine 3 can execute the settlement processing of commodities subjected to the commodity registration processing except for the commodity subjected to the cancellation processing.

Hereinafter, a modification of the embodiment will be described. In the embodiment, the registration machine key 173 is operated if the cancellation operation of the commodity is performed using the registration machine 1, and the checkout machine key 174 is operated if the cancellation operation of the commodity is performed using the checkout machine 3. In the modification, whether the cancellation operation of the commodity is performed using the registration machine 1 or using the checkout machine 3 is set (stored) in the registration machine 1 in advance, and if the setting is the registration machine 1, the cancellation operation is performed using the registration machine 1. If the setting is the checkout machine 3, the cancellation operation is performed using the checkout machine 3. That is, the store clerk does not perform the operation of selecting whether the cancellation operation of the commodity is performed using the registration machine 1 or using the checkout machine 3 every time the cancellation request is made in the registration machine 1.

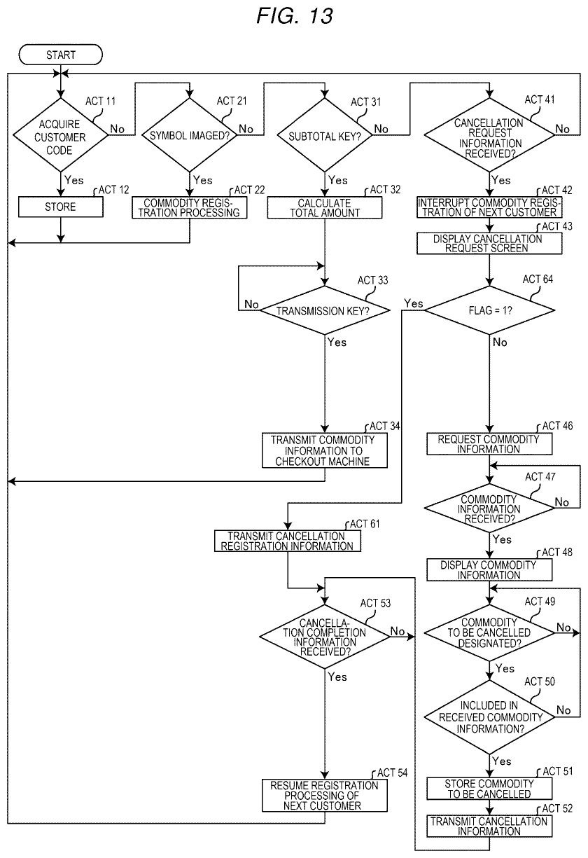

Specifically, the memory unit 14 of the registration machine 1 stores in advance selection information as to whether the cancellation operation of the commodity is performed using the registration machine 1 or using the checkout machine 3 (for example, information of flag=0 if the cancellation operation of the commodity is performed using the registration machine 1, and information of flag=1 if the cancellation operation of the commodity is performed using the checkout machine 3). The registration machine 1 performs control according to a flowchart shown in FIG. 13. In FIG. 13, the same reference numerals are given to the same processing as those in FIG. 9, and the description thereof will be omitted. In FIG. 13, if it is determined that the cancellation request information is received from the checkout machine 3 (Yes in ACT 41), the control unit 100 performs the processing of ACT 42 and the processing of ACT 43 which are the same processing as those in FIG. 9. Next, the selection unit 103 determines whether the checkout machine 3 is set (ACT 64) or the registration machine 1 is set (ACT 65) based on the selection information set (stored) in the memory unit 14. Specifically, if the flag=1 is set as the selection information, the selection unit 103 determines Yes in ACT 64, and executes the processing of ACT 61, the determination in ACT 53, and the processing of ACT 54. In addition, if the flag=0 is set as the selection information, the selection unit 103 determines No in ACT 64 and executes the processing of ACT 46 to ACT 54 and thereafter. The processing of the checkout machine 3 in the modification is the same as that in FIG. 10. That is, the selection unit 103 selects whether the cancellation operation is performed using the registration machine 1 or using the checkout machine 3 based on the selection information stored in the memory unit 14.

If the registration machine 1 according to the modification receives the cancellation request information from the checkout machine 3, the registration machine 1 can notify the store clerk of the cancellation request from the preceding customer, and can automatically select the device (the registration machine 1 or the checkout machine 3) to perform the cancellation operation based on the setting information set in advance. If the registration machine 1 is selected, the commodity to be cancelled can be designated from the registration machine 1.

As described above, according to the embodiment and the modification, the sales data processing system 10 includes: the registration machine 1 operated by a store clerk; and the checkout machine 3 operated by a customer. The registration machine 1 includes the commodity registration unit 101 configured to perform, based on an operation of the store clerk, commodity registration processing of a commodity purchased by the customer. The checkout machine 3 includes the declaration unit 301 configured to receive a declaration of cancellation of a part or all of commodities subjected to the commodity registration processing, and the notification unit 302 configured to notify the registration machine 1 of the cancellation of the commodity by the declaration unit 301. The registration machine 1 includes the notification unit 102 configured to receive the notification and notify the store clerk of the cancellation of the commodity. The checkout machine 3 includes the first acquisition unit 303 configured to acquire information on a commodity to be cancelled, which is designated based on the operation of the store clerk, the cancellation processing unit 304 configured to perform cancellation processing of the commodity for which the information is acquired by the first acquisition unit 303 among the commodities subjected to the commodity registration processing, and the settlement processing unit 305 configured to perform, based on an operation of the customer, settlement processing of the commodities subjected to the commodity registration processing performed by the registration machine 1 except for the commodity subjected to the cancellation processing performed by the cancellation processing unit 304.

According to the embodiment and the modification of such a configuration, if the checkout machine 3 receives the declaration of cancellation for the commodity subjected to the commodity registration processing, the registration machine 1 notifies the store clerk of the cancellation of the commodity, and the checkout machine 3 performs the cancellation processing based on the acquired information on the commodity to be cancelled. Therefore, the store clerk operating the registration machine 1 can recognize that the preceding customer requests the cancellation, and executes the cancellation processing of the designated commodity based on the operation of the store clerk. Therefore, in the embodiment and the modification, it is possible to simplify the cancellation of the commodity during checkout.

While the embodiment and the modification have been described, the embodiment and the modification have been presented by way of example only, and are not intended to limit the scope of the embodiment. The novel embodiment and modification thereof can be implemented in various other forms, and various omissions, replacements, and the modification can be made without departing from the gist of the embodiment. The embodiment and the modification thereof are within the scope and the gist of the embodiment, and are within a scope of the embodiment disclosed in the claims and equivalents thereof.

For example, in the embodiment, the registration machine 1 is described as an example of the first processing unit, and the checkout machine 3 is described as an example of the second processing unit. However, the embodiment is not limited thereto. For example, in a semi-self-service-type POS system, a registration machine operated by a store clerk may be set as the first processing unit, and a checkout machine operated by a customer may be set as the second processing unit.

What is claimed is:

1. A sales data processing system, comprising:
a first processing component operated by a store clerk; and
a second processing component operated by a customer, wherein
the first processing component includes
a commodity registration component configured to perform, based on an operation of the store clerk, commodity registration processing of a commodity purchased by the customer,
the second processing component includes
a declaration component configured to receive a declaration of cancellation of a part or all of commodities subjected to the commodity registration processing, and
a notification component configured to notify the first processing component of the cancellation of the commodity by the declaration component,
the first processing component further includes
a notification component configured to receive the notification from the second processing component and notify the store clerk of the cancellation of the commodity, and
the second processing component further includes
a first acquisition component configured to acquire information on the commodity to be cancelled, which is designated based on the operation of the store clerk,
a cancellation processing component configured to perform cancellation processing of the commodity for which the information is acquired by the first acquisition component among the commodities subjected to the commodity registration processing, and
a settlement processing component configured to perform, based on an operation of the customer, settlement processing of the commodities subjected to the commodity registration processing performed by the first processing component except for the commodity subjected to the cancellation processing performed by the cancellation processing component.

2. The sales data processing system according to claim 1, wherein
the first processing component further includes
a second acquisition component configured to acquire information on the commodity to be cancelled, which is designated based on the operation of the store clerk, and
a transmission component configured to transmit, to the second processing component, commodity cancellation information related to the acquired information,
the first acquisition component acquires the cancellation information transmitted by the transmission component, and
the cancellation processing component performs the cancellation processing of the commodity related to the cancellation information acquired by the first acquisition component.

3. The sales data processing system according to claim 2, wherein
the first processing component includes a selection component configured to select whether to perform a cancellation operation using the first processing component or perform the cancellation operation using the second processing component.

4. The sales data processing system according to claim 3, wherein
the first processing component includes a display component configured to display an option selectable by the selection component.

5. The sales data processing system according to claim 1, wherein
the second processing component includes a customer display component for the customer and a store clerk display component for the store clerk, and
the store clerk display component displays commodity information related to the commodities subjected to the commodity registration processing, the commodities including the commodity to be cancelled.

6. The sales data processing system according to claim 5, wherein
the customer display component displays an option for selecting the cancellation of the commodity subjected to the commodity registration processing.

7. The sales data processing system according to claim 6, wherein
the customer selects the cancellation of the commodity subjected to the commodity registration processing on the customer display by tapping an icon on the customer display or swiping the icon on the customer display.

8. A sales data processing method, comprising:
performing, based on an operation of a store clerk, commodity registration processing of a commodity purchased by a customer;
receiving a declaration of cancellation by the customer of a part or all of commodities subjected to the commodity registration processing by the customer;
notifying a first processing component of the cancellation of the commodity by the declaration;
receiving the notification from a second processing component operated by the customer and notifying the store clerk of the cancellation of the commodity, and
acquiring information on the commodity to be cancelled, which is designated based on the operation of the store clerk;
performing cancellation processing of the commodity for which the information is acquired among the commodities subjected to the commodity registration processing; and
performing, based on an operation of the customer, settlement processing of the commodities subjected to the commodity registration processing performed by the first processing component except for the commodity subjected to the cancellation processing.

9. The sales data processing method according to claim 8, further comprising:
acquiring information on the commodity to be cancelled, which is designated based on the operation of the store clerk;
transmitting commodity cancellation information related to the acquired information;
acquiring the cancellation information transmitted; and
performing cancellation processing of the commodity related to the cancellation information acquired.

10. The sales data processing method according to claim 9, further comprising:
selecting whether to perform a cancellation operation or to perform the cancellation operation.

11. The sales data processing method according to claim 10, further comprising:
displaying an option selectable by the store clerk.

12. The sales data processing method according to claim 8, further comprising:
displaying commodity information related to the commodities subjected to the commodity registration processing, the commodities including the commodity to be cancelled.

13. The sales data processing method according to claim 12, further comprising:
displaying an option for selecting the cancellation of the commodity subjected to the commodity registration processing.

14. A sales data processing system, comprising:
a server for storing information and facilitating processing;
a plurality of first processing components each operated by a store clerk; and
a corresponding plurality of a second processing components each operated by a customer, each first processing component coupled with a corresponding second processing component, wherein
each first processing component includes
a commodity registration component configured to perform, based on an operation of the store clerk, commodity registration processing of a commodity purchased by the customer,
each second processing component includes
a declaration component configured to receive a declaration of cancellation of a part or all of commodities subjected to the commodity registration processing, and
a notification component configured to notify the first processing component of the cancellation of the commodity by the declaration component,
each first processing component further includes
a notification component configured to receive the notification from the second processing component and notify the store clerk of the cancellation of the commodity, and
each second processing component further includes
a first acquisition component configured to acquire information on the commodity to be cancelled, which is designated based on the operation of the store clerk,
a cancellation processing component configured to perform cancellation processing of the commodity for which the information is acquired by the first acquisition component among the commodities subjected to the commodity registration processing, and
a settlement processing component configured to perform, based on an operation of the customer, settlement processing of the commodities subjected to the commodity registration processing performed by the first processing component except for the commodity subjected to the cancellation processing performed by the cancellation processing component.

15. The sales data processing system according to claim 14, wherein
each first processing component further includes
a second acquisition component configured to acquire information on the commodity to be cancelled, which is designated based on the operation of the store clerk, and
a transmission component configured to transmit, to the second processing component, commodity cancellation information related to the acquired information,
the first acquisition component acquires the cancellation information transmitted by the transmission component, and
the cancellation processing component performs the cancellation processing of the commodity related to the cancellation information acquired by the first acquisition component.

16. The sales data processing system according to claim 15, wherein
each first processing component includes a selection component configured to select whether to perform a cancellation operation using the first processing component or perform the cancellation operation using the second processing component.

17. The sales data processing system according to claim 16, wherein
each first processing component includes a display component configured to display an option selectable by the selection component.

18. The sales data processing system according to claim 14, wherein
each second processing component includes a customer display component for the customer and a store clerk display component for the store clerk, and
the store clerk display component displays commodity information related to the commodities subjected to the commodity registration processing, the commodities including the commodity to be cancelled.

19. The sales data processing system according to claim 18, wherein
the customer display component displays an option for selecting the cancellation of the commodity subjected to the commodity registration processing.

20. The sales data processing system according to claim 19, wherein
the customer selects the cancellation of the commodity subjected to the commodity registration processing on the customer display by tapping an icon on the customer display or swiping the icon on the customer display.
